(19) United States
(12) Patent Application Publication
(10) Pub. No.: US 2022/0134459 A1
(43) Pub. Date: May 5, 2022

(54) METHOD FOR AUTOMATIC PROCESS MONITORING IN CONTINUOUS GENERATION GRINDING

(71) Applicant: REISHAUER AG, Wallisellen (CH)

(72) Inventors: Christian DIETZ, Wallisellen (CH); André EGER, Wallbach (CH); Jürg GRAF, Fehraltorf (CH)

(73) Assignee: REISHAUER AG, Wallisellen (CH)

(21) Appl. No.: 17/433,274

(22) PCT Filed: Mar. 13, 2020
(86) PCT No.: PCT/EP2020/056862

§ 371 Date: Aug. 24, 2021

(30) Foreign Application Priority Data
Mar. 22, 2019 (CH) 374/19

(51) Int. Cl. B23F 23/12; B24B 51/00; B23F 1/02; B23F 19/05

(52) U.S. Cl. CPC B23F 23/1218; B23F 19/052; B23F 1/023; B24B 51/00

(57) ABSTRACT

A method for automatic process monitoring during continuous generating grinding of pre-toothed workpieces, which permit early detection of grinding wheel breakouts. A generating grinding machine is used to machine multiple workpieces by clamping them onto at least one workpiece spindle and successively moving them into generating engagement with a grinding wheel. At least one measured variable is monitored during the machining to indicate if a grinding wheel breakout exists. If a grinding wheel breakout is indicated, the grinding wheel is examined automatically by moving a dressing tool over the tip region of the grinding wheel and generating a contact signal. A breakout is determined by analyzing the contact signal and, if present, the grinding wheel is dressed as often as necessary in order to eliminate the grinding wheel breakout. Alternatively, the checking of the grinding wheel is carried out directly at the first dressing stroke.

### TECHNICAL FIELD

The present invention relates to a method for automatic process monitoring during continuous generating grinding with a generating grinding machine. The invention also relates to a generating grinding machine which is configured to execute such a method, and to a computer program for executing such a method.

### PRIOR ART

During continuous generating grinding, a gear wheel blank is machined in rolling engagement with a grinding wheel having a worm-shaped profile (grinding worm). Generating grinding is a very demanding, generating machining method which is based on a multiplicity of synchronized precise individual movements and is influenced by a large number of boundary conditions. Information on the basics of continuous generating grinding can be found e.g. in the book by H. Schriefer et al., “Continuous Generating Gear Grinding”, Reishauer A G, Wallisellen 2010, ISBN 978-3-033-02535-6, Chapter 2.3 (“Basic Methods of Generating Grinding”), pages 121 to 129.

The tooth flank shape during continuous generating grinding is theoretically determined solely by the dressed profile shape of the grinding worm and the setting data of the machine. However, in practice deviations from the ideal state, which decisively influence the grinding result, frequently occur in automated production. In the specified book by Schriefer et al., details are given on the above on pages 531 to 541 of Chapter 6.9 (“Practical Know-How for Statistical Individual Deviation Analysis”) and on pages 542 to 551 of Chapter 6.10 (“Analysing and Eliminating Gear Tooth Deviations”).

The quality of gears which are produced using a generating grinding method is traditionally not assessed until after the end of the machining by means of gear measurements outside the grinding machine (“offline”) on the basis of a multiplicity of measured variables. In this context there are various standards on how to measure the gears and how to check whether the measurement results are within or outside a tolerance specification. The standards also give indications as to the relationships between the measurement results and the properties of use of the gear. A summary of such gear measurements can be found e.g. in the book already mentioned by Schriefer et al. on pages 155 to 200 of Chapter 3 (“Quality Assurance in Continuous Generating Gear Grinding”).

During manual operation, the operator detects deviations from the specifications in the machining process on the basis of his experience, or deviations are detected during the subsequent checking of the gears. The operator then adjusts the machining process into a stable region again by means of changed settings. However, in order to automate the machining it is desirable that process monitoring engages in an automatically stabilizing fashion.

Until now, in the prior art only rudimentary details have been disclosed about suitable strategies for a process monitoring relating to continuous generating grinding.

For example, the company presentation “NORDMANN Tool Monitoring”, version of 5 Oct. 2017, retrieved on 25 Feb. 2019 from https://www.nordmann.eu/pdf/praesentation/Nordmann_presentation_ENG.pdf, describes various measures for monitoring tools on general metal-cutting machine tools (page 3). The monitoring of tools can occur in-process during the metal cutting operation by means of measurements of the effective power, the cutting force or acoustic emissions (page 7). It can serve, in particular, to detect tool fractures and tool wear (pages 9 to 14). There is a multiplicity of sensors available for the various measurement tasks within the scope of the monitoring of tools (pages 31 to 37). The effective power can be determined by measuring the current (page 28). Corresponding current sensors are known for this (page 37), or the monitoring of the current can be carried out without sensors on the basis of data from the CNC controller (page 40). The presentation features application examples in various metal-cutting machining methods, also including a number of brief examples of methods which are relevant when machining gearwheels, in particular gear hobbing (pages 41 and 42), hard skiving (page 59) and honing (page 60). Dressing methods are also covered (page 92). In contrast, continuous generating grinding is only mentioned marginally (e.g. pages 3 and 61).

Information on (cylindrical) grinding and dressing can also be found in Klaus Nordmann, “Prozessnberwachung beim Schleifen und Abrichten [Process monitoring during grinding and dressing]”, Schleifen+Polieren 05/2004, Fachverlag Möller, Velbert (Germany), pages 52-56. However, continuous generating grinding is not covered here in detail either.

Frequently, vitrified bonded grinding wheels which can be dressed are used for generating grinding. With such grinding worms, local breakouts in one or more worm threads of the grinding wheel are a very disruptive problem. Grinding wheel breakouts cause the tooth flanks of the gear which is to be machined to fail to be machined completely over their entire length if they are in engagement with the grinding wheel in the region of the breakout. Usually, not all the workpieces of one batch are affected to the same extent by a grinding wheel breakout since the grinding wheel is shifted along its longitudinal axis during the production of a batch, in order to continuously engage still unused regions of the grinding wheel with the workpiece (so-called shifting). Workpieces which have been machined exclusively by intact regions of the grinding wheel generally exhibit no faults.

This makes it more difficult to detect machining faults owing to grinding wheel breakouts. Since usually only sample controls are carried out during the checking of a gear, machining faults owing to grinding wheel breakouts are frequently not detected, or only detected very late, during the checking of a gear. Such faults often only come to light at end-of-line testing after the installation of the workpiece in a transmission. This entails costly deinstallation processes. In addition, the same machining faults may already have occurred on a large number of further workpieces in the interim. This can lead to a situation in which under certain circumstances considerable parts of a production batch have to be discarded as NOK parts (NOK=“not OK”). Even a single grinding wheel breakout which is not detected can therefore result in very high subsequent costs. Therefore, it is desirable to reliably detect or even prevent grinding wheel breakouts within the scope of automatic process monitoring.

In addition to grinding wheel breakouts, other phenomena can adversely affect the quality of the produced gears over one production batch. For example, it is known that frequently not all blanks can be pre-machined identically, or that differences in hardness and/or hardening distortions occur on the tooth flanks of the blanks. Small differences in the composition of the grinding worm can also lead to different grinding or dressing behaviors. Inadequate quality during dressing is another frequent cause of reductions in quality in the finished gear. In addition, during dressing the radius of the grinding worm is invariably reduced by the respective dressing amount. Therefore, during the machining of a production batch the engagement conditions during generating grinding can change drastically, and can also often worsen. The settings which are selected at the start of the machining then have to be changed. Despite all the precautions to ensure a constant machining quality, it is unavoidable that individual differences will arise on each workpiece during machining.

Accordingly, in the case of automatic generating grinding of one production batch, before the machining, the settings, the tools, the clamping means and the measurement and automation technology must be defined. At the start of the machining an operator monitors the process and after reject-free production has been achieved, the production batch is then further machined quasi-automatically. This process can become unstable or be disrupted by two significant influences:
firstly by the tool, in particular, by breakouts or by worse engagement conditions after dressing; and
secondly by the workpiece, which can have machining faults from pre-machining.

Process monitoring should then capture these influences and initiate measures for automated finishing.

### SUMMARY OF THE INVENTION

It is therefore an object of the present invention to specify a method for process monitoring during continuous generating grinding, with which process deviations can be detected and/or prevented early.

This object is achieved by means of the method in Claim 1. Further embodiments are specified in the dependent claims.

A method for process monitoring during continuous generating grinding of pre-toothed workpieces with a generating grinding machine is therefore specified. The generating grinding machine comprises a tool spindle and at least one workpiece spindle. A grinding wheel with a worm-shaped profile and with one or more worm threads is clamped onto the tool spindle and can rotate about a tool axis. The workpieces can be clamped onto the at least one workpiece spindle. The method comprises:
machining the workpieces with the generating grinding machine, wherein for the machining the workpieces are clamped onto the at least one workpiece spindle and are successively moved into generating engagement with the grinding wheel;
monitoring at least one measured variable during the machining of the workpieces; and
determining a warning indicator for a process deviation from the at least one monitored measured variable.

According to the invention, the process monitoring is therefore used to obtain information about unacceptable deviations of the machining process in a generating grinding machine from its normal operation at an early point, and to derive a warning indicator from said information. The warning indicator may in the simplest case be e.g. a binary Boolean variable which specifies in a binary fashion whether or not there is a suspicion of a process deviation. The warning indicator may, however, also be e.g. a number which is higher the greater the calculated probability of a process deviation, or a vector variable which additionally indicates the measurement(s) on the basis of which there is suspicion of a process deviation or the type of the detected possible process deviation. Many other implementations of the warning indicator are also conceivable.

In particular, the process deviation which is to be detected may be a grinding wheel breakout. Correspondingly, the warning indicator is a warning indicator which indicates a possible grinding wheel breakout. As has already been stated in the introduction, grinding wheel breakouts which remain undetected can lead to a situation in which large parts of a production batch have to be rejected as NOK parts, and it is therefore particularly advantageous if the process monitoring is configured to output a warning indicator which indicates possible grinding wheel breakouts.

Different actions may be triggered automatically on the basis of the warning indicator. Therefore, on the basis of the warning indicator it can be decided automatically that the workpiece which was machined last is excluded as an NOK part or is fed to special post-checking. On the basis of the warning indicator it is also possible to trigger an optical or acoustic warning signal in order to prompt the operator of the generating grinding machine to perform visual inspection of the grinding wheel.

The warning indicator advantageously triggers automatic checking of the grinding wheel for a grinding wheel breakout if the warning indicator indicates a grinding wheel breakout.

This automatic checking may be carried out in various ways. It is conceivable for example to use an optical sensor or a digital camera for checking and to detect automatically whether a grinding wheel breakout is present, e.g. using digital image processing methods. It is also conceivable for this purpose to check acoustic emissions of the grinding wheel which arise when a jet of coolant impacts on the grinding wheel, and which emissions are transmitted to an acoustic sensor via the jet of coolant. However, a dressing device with a dressing tool, such as is often present in any case on a generating grinding machine, is advantageously used for automatic checking. In this context, in order to check the grinding wheel it is possible either to move over only a tip region of the grinding worm threads in a targeted fashion, or a complete dressing stroke may be carried out, such as would also be carried out in the case of normal dressing of the grinding wheel.

If just the tip region is moved over, the following steps may be specifically executed as soon as the warning indicator indicates a grinding wheel breakout:
moving the dressing tool over a tip region of the grinding wheel;
determining a contact signal during the movement over the tip region, wherein the contact signal indicates contact of the dressing tool with the tip region of the grinding wheel; and
determining a breakout indicator by analyzing the contact signal, the breakout indicator indicating whether a grinding wheel breakout is present.

If contact fails to occur in a specific region of a grinding worm thread, this is a strong indication that a grinding wheel breakout is actually present. This is indicated by the breakout indicator.

This movement over the tip region with a dressing tool may also be carried out at regular intervals, independently of the value of the warning indicator, e.g. after the machining of a predefined number of workpieces, in order to also be able to detect grinding wheel breakouts which have remained undetected during monitoring of the measured variables during the machining process.

The breakout indicator may in the simplest case again be a binary Boolean variable which indicates in a binary fashion whether or not a breakout is present. However, much more complex implementations of the breakout indicator are also conceivable. In particular, the breakout indicator preferably also indicates the location of the grinding wheel breakout along at least one of the worm threads on the grinding wheel.

The contact of the dressing tool with the tip region of the grinding wheel may be detected in various ways. For example, the generating grinding machine may comprise an acoustic sensor in order to detect acoustically the engagement of the dressing tool with the grinding wheel on the basis of structure-borne acoustic emissions produced during engagement. The contact signal is then derived from an acoustic signal which is determined using the acoustic sensor. If the dressing tool is clamped onto a dressing spindle which is rotationally driven by a motor, the contact signal may instead or in addition be derived from a power signal which is representative of the power consumption of the dressing spindle during the movement over the tip region.

If the breakout indicator indicates the presence of a grinding wheel breakout, the method may provide that the grinding wheel is completely dressed in order to characterize further and/or eliminate the grinding wheel breakout.

As already stated, it is, however, also conceivable to carry out a complete dressing operation directly in order to check the grinding wheel for breakouts. In this case, the checking of the grinding wheel for breakouts and the characterization of the breakouts are carried out on the basis of monitoring this dressing operation.

In order to monitor the dressing operation and to characterize the grinding wheel breakout in more detail, it is possible to determine during the dressing a dressing power signal which is representative of the power consumption of the dressing spindle and/or of the tool spindle during the dressing, and a breakout measure may be determined by analyzing the time course of the dressing power signal during the dressing. The breakout measure reflects at least one characteristic of the grinding wheel breakout, e.g. where the grinding wheel breakout is located and/or how deeply the affected grinding worm thread is damaged in the radial direction.

The breakout measure may then be used to decide automatically whether the grinding wheel breakout can appropriately be eliminated by one or more dressing operations. If this is not the case, a signal may be output to the user to the effect that the grinding wheel has to be replaced, or the further machining may be controlled in such a way that further workpieces are machined only with undamaged regions of the grinding worm.

The analysis of the time course of the dressing power signal for determining the breakout measure may include the following step: determining a fluctuation variable, the fluctuation variable indicating local changes in the magnitude of the dressing power signal along at least one of the worm threads. For example, this fluctuation variable can permit direct conclusions to be drawn about the radial depth of the grinding wheel breakout.

As has already been stated, within the scope of the process monitoring proposed here a warning indicator is determined for a process deviation, in particular for a grinding wheel breakout, in order to obtain indications of possible process deviations at an early point. Various measured variables may be monitored in order to determine this warning indicator.

In particular, the monitored measured variables may comprise a deviation indicator for a tooth thickness deviation of the workpiece before the machining. If the deviation indicator indicates that the tooth thickness deviation exceeds an acceptable value or that other pre-machining faults are present, the warning indicator is correspondingly set in order to interrupt the machining so that damage to the grinding wheel can be avoided. If appropriate, the grinding wheel may subsequently be examined for possible breakouts owing to the inadequate pre-machining of preceding workpieces.

The deviation indicator is advantageously determined here with a meshing probe, which may be already present in the machine tool, is known per se and is designed to measure in a contactless fashion the tooth gaps of the workpiece which is clamped onto the workpiece spindle. The tooth thickness measurement may then be calibrated with a calibration workpiece, and limiting values which the signals of the meshing probe have to comply with for the tooth thickness deviation to be considered as acceptable may be defined. For example an inductive or capacitive sensor which operates in a contactless fashion may be used as a meshing probe. In this case the meshing probe therefore satisfies a double function: on the one hand it is used for meshing at the start of machining, and on the other hand it serves to determine a tooth thickness deviation. Instead of the meshing probe it is, however, also possible to use a separate sensor for determining the tooth thicknesses, e.g. a separate optical sensor, which possibly may be preferred in the case of high rotational speeds.

An early indication of the risk of a grinding wheel breakout can also already be obtained by virtue of the fact that the monitored measured variables comprise a rotational speed difference between a rotational speed of the workpiece spindle and a resulting rotational speed of the workpiece. If such a difference is present, this indicates that the workpiece has not been correctly clamped onto the workpiece spindle and therefore has not been correctly entrained by said spindle (slip). This can lead to a situation in which the workpiece is not located in the correct angular position when it is moved into engagement with the grinding worm, so that the grinding worm threads cannot dip correctly into the tooth gaps of the workpiece. In such a situation, the workpiece is not machined correctly, and high machining forces can occur, which can be so high that the grinding worm is seriously damaged. By monitoring the rotational speeds of the workpiece spindle and workpiece it is possible to detect such situations and stop the machining process ideally already before the workpiece enters into engagement with the grinding worm. A grinding wheel breakout can possibly still be avoided. If a rotational speed deviation is detected, the warning indicator is correspondingly set. If appropriate, the grinding wheel is examined for damage on the basis of the warning indicator.

Further relevant measured variables are the rotational angle positions of the workpiece spindle and of the workpiece which is clamped thereon before and after the machining and/or the change in these rotational angle positions during the machining. In particular, the monitored measured variables may comprise an angular deviation which has been determined by a comparison of an angular position of the workpiece spindle after the machining of the workpiece, a corresponding angular position of the workpiece itself, an angular position of the workpiece spindle before the machining of the workpiece and a corresponding angular position of the workpiece itself. If this angular deviation indicates that the angular difference between the angular positions after the machining and the angular positions before the machining on the workpiece spindle and on the workpiece itself differ from one another, this is in turn an indication that the workpiece has not been correctly entrained by the workpiece spindle. This in turn constitutes a reason to set the warning indicator correspondingly and, if appropriate for the sake of safety, to examine the grinding wheel for damage.

The rotational speed and/or angular position of the workpiece are/is also advantageously determined here with the meshing probe which has already been mentioned. Again, the meshing probe satisfies a double function here: on the one hand it is used for meshing before the start of machining, and on the other hand it serves to monitor the actual machining process. However, instead of the meshing probe it is also possible to use in turn a separate sensor for determining the rotational speed and/or angular position of the workpiece, e.g. a separate optical sensor, which possibly may be preferred at high rotational speeds.

The meshing probe may advantageously be arranged on a side of the workpiece facing away from the grinding wheel. In this way, there is no collision between the grinding wheel and the meshing probe and sufficient space remains for parallel, laterally arranged gripping jaws for handling the workpiece.

The monitored measured variables may also comprise a cutting power signal which indicates an instantaneous metal-cutting power during the processing of each machining individual workpiece. In this case, the warning indicator may depend on the time course of the cutting power signal over the machining of a workpiece. In particular, the occurrence of a pulse-like increase in the cutting power signal during the machining can be an indication of a collision of the workpiece with a grinding worm thread, which can give rise to a grinding wheel breakout, and the warning indicator may correspondingly indicate this. The cutting power signal may be determined, in particular, by means of a current measurement on the tool spindle and may in this respect be a measure of the instantaneous power consumption of the tool spindle during the machining of a workpiece.

A further possible way of determining the warning indicator arises from the following considerations: during the machining of a workpiece with a damaged grinding wheel, the removed quantity of material in the region of the grinding wheel breakout is smaller than in the intact regions of the grinding wheel. In the course of the shifting movement, the workpieces increasingly move into the region of the grinding wheel breakout and/or out of this region. Correspondingly, the removed quantity of material per workpiece will correspondingly first drop and then rise again. This is reflected directly in the applied metal-cutting energy per workpiece, that is to say in the integral of the metal-cutting power over time.

The method may in this respect comprise the execution of a continuous or discontinuous shifting movement between the grinding wheel and the workpieces along the tool axis. The monitored measured variables may then comprise a cutting energy indicator for each workpiece, wherein the cutting energy indicator represents a measure for an integrated metal-cutting power of the grinding wheel while the respective workpiece was machined with the generating grinding machine. The warning indicator may then depend on how the cutting energy indicator changes over the production of a plurality of workpieces of one production batch, that is to say from workpiece to workpiece.

The cutting energy indicator may be, in particular, the integral of the power consumption of the tool spindle during the machining of an individual workpiece. However, the cutting energy indicator may instead also be another characteristic value which has been derived from the power consumption of the tool spindle over the machining of an individual workpiece, e.g., it may be a suitably determined maximum value of the power consumption.

In order to still be able to carry out an analysis retrospectively, it is advantageous if the monitored measured variables and/or variables derived therefrom, in particular the warning indicator, are stored together with an unambiguous identifier of the respective workpiece in a database. These data may be read out again later at any time, e.g. within the scope of later machining of the same type of workpieces.

The invention also relates to a generating grinding machine which is designed to execute the method explained above. For this purpose it comprises:
a tool spindle on which a grinding wheel having a worm-shaped profile with one or more worm threads can be clamped, and which can be driven to rotate about a tool axis;
at least one workpiece spindle for driving one pre-toothed workpiece at a time to rotate about a workpiece axis; and
a machine controller which is designed to execute the method of the type explained above.

The generating grinding machine may comprise further components such as are mentioned above in the context of the various methods.

In particular, the generating grinding machine may comprise a deviation-determining device, in order to determine an upper deviation of the tooth thicknesses of a workpiece to be processed. As already mentioned, the dimension-determining device may, in particular, receive and evaluate signals from the meshing probe.

The generating grinding machine may also comprise a first rotational angle sensor for determining a rotational angle of the workpiece spindle, and a second rotational angle sensor for determining a rotational angle of the workpiece about the workpiece axis. As already mentioned, the meshing probe may in turn serve as a second rotational angle sensor. The corresponding rotational angles may be determined by a rotational angle-determining device from the signals of the rotational angle sensors, and the corresponding rotational speeds can be derived from said signals by a rotational speed-determining device.

The machine controller of the generating grinding machine may additionally comprise a cutting power-determining device in order to determine the cutting power signal explained above, and an analysis device which is designed to analyze how the cutting power signal changes over time during the machining of a workpiece. The machine controller may also comprise a cutting energy-determining device in order to calculate the cutting energy indicator for each workpiece, and a further analysis device which is designed to analyze how the cutting energy indicator changes from workpiece to workpiece of a production batch. These devices may be implemented using software, e.g. by the machine controller comprising a microprocessor which is programmed to execute the abovementioned tasks. The cutting power-determining device may be designed, for example, to read out power signals from an axis module for actuating the tool spindle, and the cutting energy-determining device may be designed to integrate these signals over the machining of a workpiece.

The machine controller may also comprise the database which is mentioned above and in which the measured variables and, if appropriate, variables derived therefrom can be stored together with an unambiguous identifier of the respective workpiece and, if appropriate, further process parameters. The database may, however, also be implemented in a separate server which is connected to the machine controller via a network.

The machine controller may additionally have an output device for outputting a warning signal, e.g. an interface for emitting the warning signal in digital form to a device connected downstream, a display for displaying the warning signal, an acoustic output device etc.

The generating grinding machine may also advantageously comprise the above-mentioned dressing device, and the machine controller may comprise a dressing control device for controlling the dressing spindle and a dressing monitoring device in order to determine the above-mentioned contact signal and/or the dressing power signal and to determine the above-mentioned breakout indicator or the breakout measure from the time course of the signals. These devices may in turn be implemented using software. In addition, the machine controller may comprise an output device in order to output the breakout indicator or the breakout measure.

In order to detect contact of the dressing tool with the grinding wheel, the generating grinding machine may comprise the acoustic sensor which has already been mentioned. The generating grinding machine may also comprise a power-measuring device for determining the power consumption of the dressing spindle and/or a corresponding power-measuring device for determining the power consumption of the tool spindle. For this purpose, the corresponding power-measuring device may be designed, for example, to read out current signals from an axis module for actuating the dressing spindle and/or the tool spindle.

In order to carry out the process monitoring, the generating grinding machine may comprise a correspondingly configured control device. The latter may comprise, in particular, the already-mentioned dimension-determining device, rotational angle-determining device, rotational speed-determining device, cutting power-determining device, cutting energy-determining device, analysis devices, dressing monitoring device, power-measuring devices and output devices.

The present invention also makes available a computer program. The computer program comprises instructions which cause a machine controller in a generating grinding machine of the type explained above, in particular one or more processors of the machine controller, to execute the methods explained above. The computer program can be stored in a suitable memory device, for example a separate control device with a server. In particular, a computer-readable medium is also proposed on which the computer program is stored. The medium may be a non-volatile medium, for example a flash memory, a CD, a hard disc etc.

### BRIEF DESCRIPTION OF THE DRAWINGS

Preferred embodiments of the invention are described below with reference to the drawings which serve merely for explanation and are not to be configured in a limiting fashion. In the drawings:

FIG. 1 shows a schematic view of a generating grinding machine;

FIG. 2 shows an enlarged detail from FIG. 1 in region II;

FIG. 3 shows an enlarged detail from FIG. 1 in region III;

FIG. 4 shows four photographs of a grinding wheel with breakouts in one or more worm threads;

FIG. 5 shows a photograph of a damaged gearwheel;

FIG. 6 shows a diagram which indicates, by way of example, characteristic signals of the meshing probe in the case of good pre-machining and poor pre-machining (fluctuation of the upper tooth thickness deviation) of two workpieces;

FIG. 7 shows a diagram which shows in part (a) the time course of the rotational speed of the workpiece spindle during the revving up to the working rotational speed, and in part (b) the resulting signals of the meshing probe in the case of incomplete entrainment of the workpiece;

FIG. 8 shows a diagram which shows the time course of the power consumption of the tool spindle during the machining of a workpiece when the grinding wheel moves into contact with a workpiece which is not located in the correct angular position;

FIG. 9 shows a diagram which shows the time courses of the power consumption of the tool spindle during the machining of a workpiece without a breakout and with a large breakout of the grinding wheel;

FIG. 10 shows a diagram which shows the time course of the average power consumption of the tool spindle during the machining of a workpiece over a production batch with a grinding wheel with a large breakout;

FIG. 11 shows a diagram which shows, by way of example, the time course of an acoustic signal during the tip dressing of a grinding wheel with a breakout;

FIG. 12 shows two diagrams which show the time course of the power consumption of the dressing spindle, (a) for a grinding wheel without breakouts, and (b) for a grinding wheel with a breakout;

FIG. 13 shows two diagrams which show the time course of the power consumption of the dressing spindle (part (a)) and of the tool spindle (part (b)) during the dressing of a grinding wheel with a breakout;

FIG. 14 shows a flow diagram for a method for process monitoring, in order to detect grinding wheel breakouts at an early point; and

FIG. 15 shows a flow diagram for further processes after the detection of a grinding wheel breakout.

### DESCRIPTION OF PREFERRED EMBODIMENTS

Exemplary Design of a Generating Grinding Machine

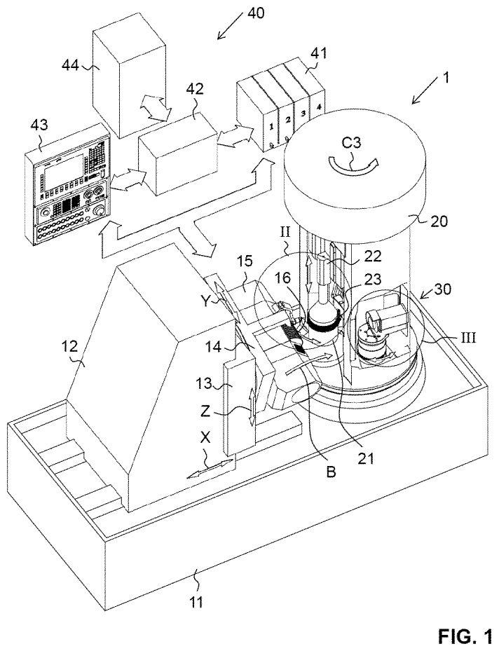

FIG. 1 illustrates, by way of example, a generating grinding machine 1. The machine has a machine bed 11 on which a tool carrier 12 is guided so as to be movable along an infeed direction X. The tool carrier 12 bears an axial carriage 13 which is guided so as to be movable along an axial direction Z with respect to the tool carrier 12. A grinding head 14 is mounted on the axial carriage 13 and, in order to adapt to the helix angle of the gear to be processed, it can pivot about a pivoting axis (the so-called A axis) running parallel to the X axis. The grinding head 14 in turn bears a shift carriage on which a tool spindle 15 can move along a shift axis Y with respect to the grinding head 14. A grinding wheel 16 having a worm profile is clamped onto the tool spindle 15. The grinding wheel 16 is driven to rotate about a tool axis B by the tool spindle 15.

The machine bed 11 also bears a pivotable workpiece carrier 20 in the form of rotatable tower which can pivot about an axis C3 between at least three positions. Two identical workpiece spindles which are diametrically opposite one another are mounted on the workpiece carrier 20, of which only one workpiece spindle 21 can be seen in FIG. 1 with an associated tailstock 22. The workpiece spindle which can be seen in FIG. 1 is located in a machining position in which a workpiece 23 which is clamped on it can be machined with the grinding wheel 16. The other workpiece spindle (which cannot be seen in FIG. 1) which is arranged offset by 180° is located in a workpiece changing position in which a workpiece which is fully machined can be removed from this spindle and a new blank can be clamped on. A dressing (truing) device 30 is mounted offset by 90° with respect to the workpiece spindles.

All the driven axes of the generating grinding machine 1 are controlled in a digital fashion by a machine controller 40. The machine controller 40 receives sensor signals from a multiplicity of sensors in the generating grinding machine 1 and emits control signals to the actuators of the generating grinding machine 1 in accordance with these sensor signals. The machine controller 40 comprises, in particular, a plurality of axis modules 41 which make available, at their output, control signals for, in each case, one machine axis (i.e. for at least one actuator which serves to drive the respective machine axis, such as for example a servomotor). The machine controller 40 further comprises an operator control panel 43 as well as a control device 42 with a control computer, which control device 42 interacts with the operator control panel 43 and the axis modules 41. The control device 42 receives operating instructions from the operator control panel 43 as well as sensor signals and calculates control instructions for the axis modules therefrom. It also outputs operating parameters to the operator control panel 43 for display on the basis of the sensor signals.

A server 44 is connected to the control device 42. The control device 42 transfers an unambiguous identifier and selected operating parameters (in particular measured variables and variables derived therefrom) for each workpiece to the server 44. The server 44 stores this data in a database, so that the associated operating parameters can be retrieved subsequently for each workpiece. The server 44 can be arranged inside the machine or can be arranged remotely from the machine. In the latter case, the server 44 can be connected to the control device 42 via a network, in particular via a company-internal LAN, via a WAN or via the Internet. The server 44 is preferably designed to receive and manage data from a single generating grinding machine. When a plurality of generating grinding machines are used, a second server is generally used because in this way central access to the stored data and better handling of the large quantity of data can be carried out. Furthermore, this data can be protected better on a second server.

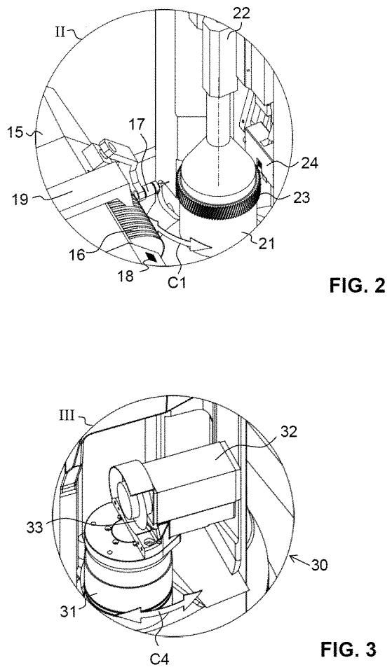

FIG. 2 illustrates the detail II from FIG. 1 in an enlarged form. It is possible to see the tool spindle 15 with the grinding wheel 16 clamped thereon. A measuring probe 17 is pivotably mounted on a fixed part of the tool spindle 15. This measuring probe 17 can optionally be pivoted between the measuring position in FIG. 2 and a parked position. In the measuring position, the measuring probe 17 can be used to measure the toothing of a workpiece 23 on the workpiece spindle 21 in a contacting fashion. This takes place “inline”, i.e. while the workpiece 23 is still located on the workpiece spindle 21. As a result, machining faults can be detected at an early point. In the parked position the measuring probe 17 is in a range in which it is protected against collisions with the workpiece spindle 21, the tailstock 22, workpiece 23 and further components on the workpiece carrier 20. During the machining of the workpiece the measuring probe 17 is in the parked position.

A meshing probe 24 is arranged on a side of the workpiece 23 facing away from the grinding wheel 16. In the present example, the meshing probe 24 is configured and arranged according to document WO 2017/194251 A1. Reference is made expressly to the specified document with respect to the method of functioning and arrangement of the meshing probe. In particular, the meshing probe 24 can comprise a proximity sensor which operates inductively or capacitively, as is well known from the prior art. However, it is also conceivable to use an optically operating sensor for the meshing operation, which e.g. directs a light beam on the gear to be measured and detects the light reflected therefrom or detects the interruption in a light beam by the gear to be measured while said gear rotates about the workpiece axis C1. Furthermore it is conceivable that one or more further sensors are arranged on the meshing probe 24, which sensors can acquire process data directly on the workpiece, as has been proposed, for example, in U.S. Pat. No. 6,577,917 B1. Such further sensors can comprise, for example, a second meshing sensor for a second gear, a temperature sensor, a further acoustic emission sensor, a pneumatic sensor etc.

Furthermore, an acoustic sensor 18 is indicated in a purely symbolic fashion in FIG. 2. The acoustic sensor 18 serves to pick up the structure-borne sound of the tool spindle 15 which is generated during the grinding machining of a workpiece and during the dressing of the grinding wheel. In reality, the acoustic sensor will usually not be arranged on a housing part (as indicated in FIG. 2) but rather e.g. directly on the stator of the drive motor of the tool spindle 15, in order to ensure efficient transmission of sound. Acoustic sensors or structure-borne sound sensors of the specified type are well known per se and are used on a routine basis in generating grinding machines.

A coolant nozzle 19 directs a jet of coolant into the machining zone. In order to record noises which are transmitted via this jet of coolant, a further acoustic sensor (not illustrated) can be provided.

The detail III from FIG. 1 is illustrated in an enlarged form in FIG. 3. The dressing device 30 is visible here particularly well. A dressing spindle 32, on which a disc-shaped dressing tool 33 is clamped, is arranged on a pivoting drive 31, so as to be pivotable about an axis C4. Instead or in addition, a fixed dressing tool can be provided, in particular what is known in the art as a tip dressing device, which is provided to enter into engagement only with the tip regions of the worm threads of the grinding wheel, in order to dress these tip regions.

Machining of a Workpiece Batch

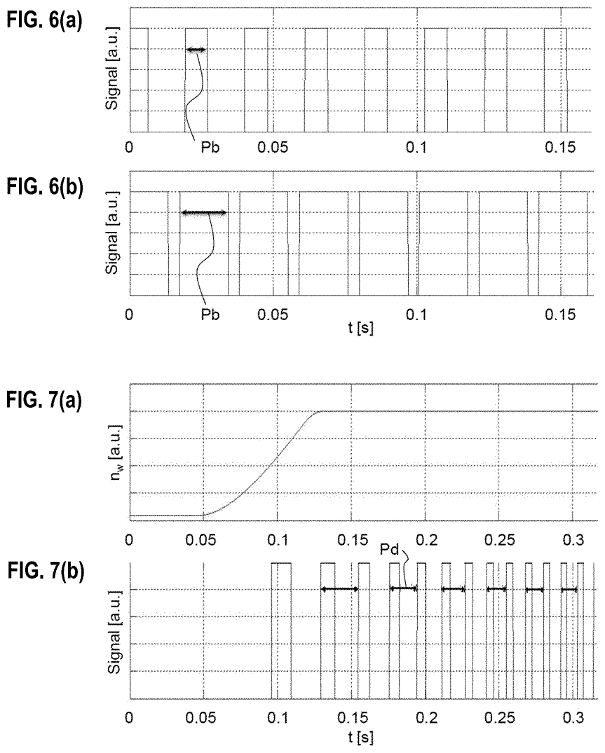

In order to machine a still unmachined workpiece (blank), the workpiece is clamped by an automatic workpiece changer onto that workpiece spindle which is located in the workpiece changing position. The workpiece change is carried out simultaneously with the machining of another workpiece on the other workpiece spindle which is located in the machining position. When the workpiece to be newly machined is clamped on and the machining of the other workpiece is concluded, the workpiece carrier 20 is pivoted through 180° about the C3 axis so that the spindle with the workpiece to be newly machined moves into the machining position. A meshing (centering) operation is carried out before and/or during the pivoting process, using the corresponding meshing probe. To do this, the workpiece spindle 21 is rotated and the positions of the tooth gaps of the workpiece 23 are measured using the meshing probe 24. The rolling angle is determined on this basis. In addition, indications about excessive variation of the upper tooth thickness deviation and other pre-machining faults can be derived using the meshing probe, even before the start of the machining. This is explained in more detail below in conjunction with FIG. 6.

When the workpiece spindle which bears the workpiece 23 to be machined has reached the machining position, the workpiece 23 is moved without collision into engagement with the grinding wheel 16 by moving the workpiece carrier 12 along the X axis. The workpiece 23 is then machined in rolling engagement by the grinding wheel 16. During this time, the tool spindle 15 is slowly shifted continuously along the shifting axis Y in order to continually allow still unused regions of the grinding wheel 16 to come into use during the machining (so-called shifting movement). As soon as the machining of the workpiece 23 is concluded, the workpiece is optionally measured inline using the measuring probe 17.

Simultaneously with the machining, the completely machined workpiece is removed from the other workpiece spindle, and a further blank is clamped onto this spindle. Each time the workpiece carrier pivots about the C3 axis, selected components are monitored before the pivoting or within the pivoting time, that is to say in a time-neutral fashion, and the machining process is not continued until all the defined requirements are satisfied.

If after machining of a specific number of workpieces the use of the grinding wheel 16 has progressed so far that the grinding wheel is too blunt and/or the flank geometry is too imprecise, the grinding wheel is then dressed. For this purpose, the workpiece carrier 20 is pivoted through ±90° so that the dressing device 30 moves into a position in which it lies opposite the grinding wheel 16. The grinding wheel 16 is then dressed with the dressing tool 33.

Grinding Wheel Breakouts

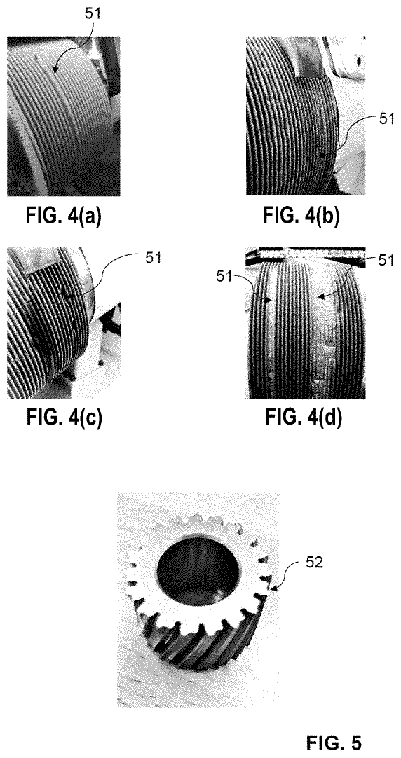

Grinding wheel breakouts can occur during the machining. FIG. 4 illustrates various forms of grinding wheel breakouts 51 on grinding worms. In part (a), a single worm thread has almost completely broken away over a certain angular range. In contrast, in part (b) a plurality of worm threads are damaged locally at a large number of various points in their tip region. There are also a plurality of local damaged areas present in part (c), but these are deeper than in part (b). In part (d), the grinding wheel is seriously damaged in two regions, wherein a plurality of adjacent worm threads have almost completely broken away in these regions. All of the instances of damage can occur in practice and have different effects during the machining of workpieces.

FIG. 5 illustrates an incorrectly machined gearwheel. All the teeth 52 are damaged in their tip region because the gearwheel was placed in engagement with the grinding wheel at an incorrect angular position so that the grinding wheel threads could not engage correctly in the tooth gaps of the gearwheel. Such a situation can occur if the meshing operation has been carried out incorrectly or if the gearwheel was not correctly entrained during the revving up of the workpiece spindle to its operating rotational speed. The situation frequently leads not only to damage to the gearwheel but also to serious grinding wheel breakouts of the grinding wheel. The situation should also be detected and prevented as early as possible.

Indications of Possible Grinding Wheel Breakouts Through Process Monitoring

In order to prevent grinding wheel breakouts as far as possible or to be able to detect at an early point breakouts which have taken place, various operating parameters are continually monitored during the machining of a production batch. The parameters or variables derived therefrom are additionally stored in a database in order to be able to perform subsequent analyses. In the present context, the rotational speeds, angular positions and power consumption values of the tool spindles, workpiece spindles and dressing spindles, the rotational speed and angular position of the workpiece itself, the signals of the meshing probe and position of the linear axes of the machine are of particular importance. In the exemplary embodiment in FIGS. 1 to 3, the control device 42 serves for monitoring. In particular, the operating parameters of the generating grinding machine which are discussed below are monitored:

(a) Determining Pre-Machining Faults Using the Meshing Probe

FIG. 6 illustrates typical signals such as are received from the meshing probe 24. These are binary signals which indicate a logic one when a tooth tip region is located before the meshing probe, and which indicates a logic zero when the tooth gap is located before the meshing probe. The pulse width Pb and/or the pulse duty factor of the signals of the meshing probe which are derived therefrom are a measure for the tooth thickness and therefore for the deviation between the measured thickness and the desired thickness (“deviation indicator”). In part (a) of FIG. 6, the pulse width Pb is small, which indicates a small (possibly even negative) deviation, while in part (b) the pulse width Pb is large, which indicates a large (possibly excessively large) deviation. The variation of the pulse width Pb is illustrated intentionally in an exaggerated form here for illustration purposes.

Therefore, direct conclusions can be drawn from the signal pattern of the meshing probe 24 about the deviations of each tooth. Indications about pre-machining faults such as an excessively large deviation or irregular deviation can be derived therefrom.

The control device 42 receives the signals of the meshing probe and derives therefrom a warning indicator which indicates whether indications about pre-machining faults are present. If this is the case, the machining is stopped before contact occurs between the workpiece 23 and the grinding wheel 16, in order to prevent damage to the grinding wheel 16. In addition, the warning indicator can trigger checking of the grinding wheel for damage by preceding workpieces.

(b) Monitoring the Rotational Speeds of the Workpiece Spindle and of the Workpiece

FIG. 7 illustrates how the rotational speed n_{w} of the workpiece spindle 21 and the resulting rotational speed of the workpiece 23 which is clamped thereon are compared with one another. The rotational speed n_{w} of the workpiece spindle 21 can be read out directly from the machine controller (part (a) of FIG. 7). In contrast, the rotational speed of the workpiece is in turn determined using the meshing probe 24. In this respect, FIG. 7 shows, in part (b), typical signals such as are received by the meshing probe 24. In the present example, the signals have a continuously decreasing period length Pd, while the workpiece spindle has already reached the desired rotational speed. Said signals therefore indicate that the workpiece 23 is still accelerating while the workpiece spindle 21 has already reached its desired rotational speed. In the present example, the workpiece 23 is therefore not entrained correctly on the workpiece spindle 21.

Such a case can occur if the tolerance values during the pre-machining of the workpiece clamping bases, such as the bore and the plane faces are exceeded. The entrainment of the workpiece generally occurs in a defined frictional engagement; i.e. a frictional torque acts on the workpiece bore through the widening of a collet chuck, and a radial frictional force is generated on the two plane faces by means of an axial contact pressing force. However, if the workpiece bore is too large and/or if the plane faces are too oblique, this frictional engagement is reduced, and beyond a critical value, a slip arises between the workpiece spindle and the workpiece.

If deviations are determined between the rotational speeds of the workpiece and of the workpiece spindle it is appropriate to stop the further machining immediately in order to prevent damage to the grinding wheel 16. Since it cannot be ruled out that damage has already occurred to the grinding wheel 16, it is additionally appropriate to examine the grinding wheel 16 for damage.

For this purpose, the control device 42 monitors the signals of the meshing probe 24 and the rotational speed signal of the workpiece spindle from the assigned axis module 41. In the case of a deviation, the control device 42 sets a warning indicator. The machining is stopped on the basis of the warning indicator before a contact occurs between the workpiece 23 and the grinding wheel 16. In addition, the warning indicator can trigger checking of the grinding wheel for damage by preceding workpieces.

(c) Monitoring of the Rotational Angles of the Workpiece Spindle and Workpiece

As an alternative or in addition to the comparison of the rotational speeds it is also possible for a comparison of the rotational angles of the workpiece spindle and associated workpiece to be carried out before and after the machining. The presence of deviations here also indicates that slip is present and it is appropriate to examine the grinding wheel 16 for possible damage. Correspondingly, the control device 42 also sets a warning indicator in this case.

(d) Monitoring of the Instantaneous Metal-Cutting Power

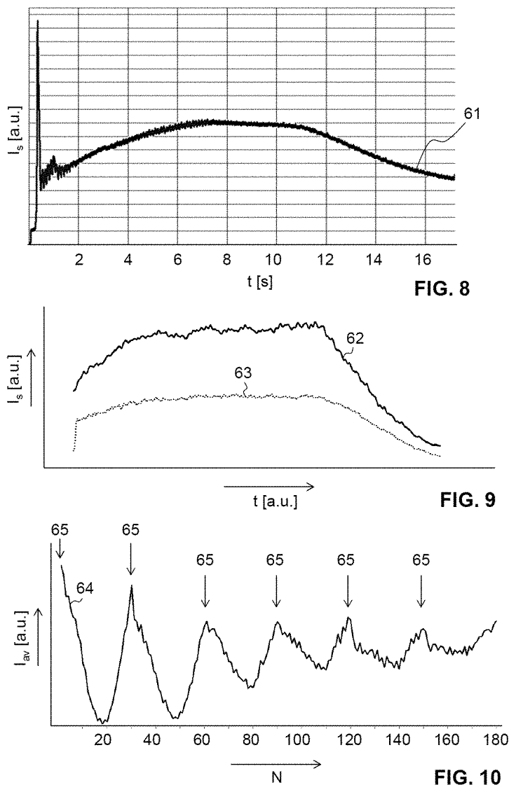

A further possible way of detecting possible grinding wheel breakouts at an early point is illustrated in FIG. 8. The Figure shows, in measurement curve 61, the power consumption Iₛ of the tool spindle as a function of the time during the machining of an individual workpiece. The power consumption (current consumption) Iₛ of the tool spindle is a direct indicator of the instantaneous metal-cutting power. In this respect it can be considered to be an example of a cutting power signal.

In the present example, the curve 61 shows a sudden steep rise and subsequent steep drop in this power consumption at the start of the machining. This indicates that a collision of one of the teeth of the workpiece with a worm thread of the grinding wheel 16 has taken place. In this case it is also appropriate to stop the further machining immediately and to examine the grinding wheel 16 for possible damage. The control device 42 again sets a corresponding warning indicator.

(e) Monitoring of the Metal-Cutting Energy Per Workpiece

A further possibility for (albeit relatively late) detection of possible grinding wheel breakouts is to monitor the energy which has been used for the metal-cutting machining of each workpiece (“metal-cutting energy”). This energy is a measure of the cut quantity of material during the machining of the respective workpiece. During the machining with a grinding worm region which is damaged by a breakout, the cut quantity of material is generally smaller than during the machining with an undamaged grinding worm region. It is therefore possible to obtain indications of a possible grinding wheel breakout by monitoring the metal-cutting energy per workpiece.

This is illustrated in more detail in FIGS. 9 and 10. FIG. 9 shows, in measurement curve 62, the power consumption Iₛ of the tool spindle as a function of the time during the machining of an individual workpiece with an undamaged grinding worm. On the other hand, the measurement curve 63 illustrates the time course of the power consumption during the machining with a grinding worm in the region of a large breakout. Owing to the breakout, the metal-cutting power and therefore the power consumption of the tool spindle are greatly reduced. The integral of the power consumption during the period of time which is required for machining an individual workpiece (that is to say the area under the respective measurement curve) is a measure of the entire metal-cutting energy which was used for the workpiece, that is to say for the cut quantity of material per workpiece. During the machining in the region of a grinding wheel breakout, this integral is smaller than during the machining of an undamaged region of the grinding wheel.

Instead of the integral of the power consumption, other variables can also be used as a measure of the total metal-cutting energy, e.g. the mean value, the maximum (if appropriate after a smoothing operation, in order to eliminate spurious values) or the result of a fit to a predefined form of the time course of the current. The measure of the total metal-cutting energy is also referred to as the cutting energy indicator in the present context.

FIG. 10 illustrates how the average power consumption Iₐᵥ of the tool spindle changes from workpiece to workpiece N during the machining if the grinding wheel is damaged. The machining starts with a grinding wheel which has a large central breakout. At the start of the machining cycle, the workpieces are machined with a first, undamaged end of the grinding wheel. In the course of the machining, the grinding wheel is continuously shifted so that the region with the breakout is increasingly used for machining. Towards the end of the cycle, the opposite end of the grinding wheel, which is also undamaged, enters into engagement with the workpiece. Correspondingly, the average power consumption Iₐᵥ of the tool spindle first decreases, before then rising again towards the end of the cycle. This results in a characteristic time course of the average power consumption Iₐᵥ from the first to the Nth workpiece.

A cycle ends in each case at the point 65, the grinding wheel is dressed and a new cycle begins. During the dressing, the damaged worm threads are gradually restored so that the changes of the average power consumption Iₐᵥ become smaller and smaller in later cycles.

A time course 64 of the current such as has been illustrated by way of example in FIG. 10 can therefore be evaluated as an indicator of a grinding wheel breakout. In order to check whether a breakout is actually present it is also appropriate here to stop the machining and to examine the grinding wheel for possible damage. For this purpose, the control device 42 also sets a corresponding warning indicator in this case.

Automatic Checking of the Grinding Wheel for Breakouts

Checking of the grinding wheel for possible damage can be carried out automatically by virtue of the fact that a dressing tool is moved over the grinding wheel in the tip region of its worm threads, and the contact between the grinding wheel and the dressing tool is detected.

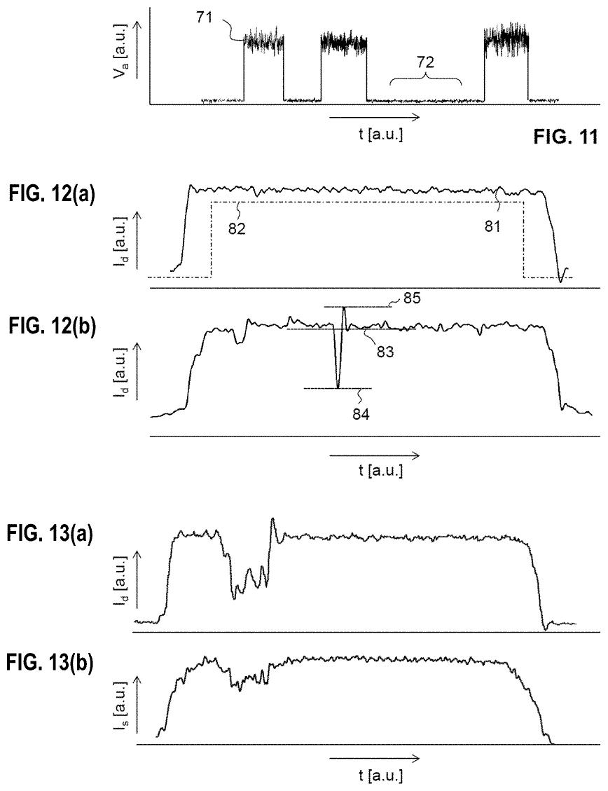

The detection of the contact can be carried out acoustically, as is illustrated in FIG. 11. For example, the time course of an acoustic signal Vₐ, such as can be determined, for example, by the acoustic sensor 18 indicated in FIG. 2, during a dressing process in which the dressing tool is intentionally brought into contact only with the tip regions of the worm threads is illustrated by way of example as a measuring curve 71. The signal indicates when the dressing device moves into engagement with the tip regions and out of engagement from said regions. In the case of an undamaged grinding wheel, a periodic signal is to be expected. On the other hand, if the signal has gaps, like the gap 72 in FIG. 11, this indicates a breakout in a worm thread.

Alternatively, a dressing process can also be directly started in an automatic fashion, as is described below, since even in the case of dressing it can be reliably detected whether grinding wheel breakouts are present. However, it is disadvantageous that in the case of dressing a significantly lower grinding wheel rotational speed has to be used and therefore the non-productive time for this control measure is somewhat lengthened.

Other methods for automatically checking the grinding wheel for damage are also conceivable. Therefore, it is e.g. possible to examine the grinding wheel for damage with an optical sensor, or it is possible to examine the grinding wheel for damage using the noises which are produced by the jet of coolant from the coolant nozzle 19 when said jet impacts on the grinding wheel. Measurements of structure-borne sound by means of the jet of coolant are known per se (see e.g. Klaus Nordmann, “ProzessUberwachung beim Schleifen und Abrichten [Process monitoring when grinding and dressing]”, Schleifen+Polieren 05/2004, Fachverlag Möller, Velbert (Germany), pages 52-56), but they have not been used to detect grinding wheel breakouts.

Further Characterization of the Grinding Wheel Breakout

If a breakout has been reliably confirmed in this way it is appropriate to dress the grinding worm completely and at the same time determine further characteristics of the breakout and/or eliminate the breakout. This is illustrated in FIGS. 12 and 13.

FIG. 12 illustrates how a grinding wheel breakout can be characterized in more detail by means of measurements of the current during dressing. FIG. 12 shows, in part (a) a measurement curve 81 which illustrates a typical time course of the power consumption I_{d} of the dressing spindle as a function of the time during the dressing of a grinding wheel if the grinding wheel has worn uniformly and does not have any breakouts. The measurement curve 81 is above a lower envelope curve 82 at all times. In part (b), the time course of the power consumption I_{d} is illustrated for a grinding wheel with a single deep breakout. In the period of time in which the dressing tool operates in the region of the grinding wheel breakout, the power consumption I_{d} shows strong fluctuations, in particular a strong dip.

In the simplest case, such fluctuations can be detected by virtue of the fact that it is monitored whether the value of the power consumption drops below the lower envelope curve 82. In regions in which this is the case, it is possible to conclude that there is a grinding wheel breakout. Of course, it is, however, also possible for more refined methods for detecting fluctuations of the power consumption to be used. For example, a mean value 83 of the power consumption can be formed and it can be monitored whether deviations therefrom in the downward direction (here: in the case of the minimum value 84) and/or in the upward direction (here: in the case of the maximum value 85) lie within a certain tolerance range. Irrespective of how the detection of the fluctuations takes place in each case, the position of the breakout along the respective worm thread can be concluded on the basis of the time or rotational angle at which the fluctuations take place. The degree of damage of the worm thread can be inferred from the magnitude of the fluctuations.

FIG. 13 illustrates that not only the power consumption of the dressing spindle but also the power consumption of the tool spindle can be used to characterize grinding wheel breakouts. In part (a) the time course of the power consumption I_{d} of the dressing spindle is illustrated, and in part (b) the time course of the power consumption Iₛ of the tool spindle during the dressing of a grinding wheel with a breakout is illustrated. It is apparent that not only the power consumption of the dressing spindle but also the power consumption of the tool spindle exhibit fluctuations in the period of time in which the dressing takes place in the region of the breakout. However, these fluctuations are more pronounced in the case of the power consumption of the dressing spindle, so that generally the power consumption of the dressing spindle is preferred as a measured variable for characterizing a grinding wheel breakout over the power consumption of the tool spindle.

The grinding wheel breakout which is characterized in this way can be eliminated through, possibly repeated, dressing. If the breakout is very large and eliminating it by dressing would require too much time, it may also be appropriate to dispense with further dressing processes and instead to replace the damaged grinding wheel or to use the grinding worm only in its undamaged regions for the further machining of the workpiece.

Example of a Method for Automatic Process Control

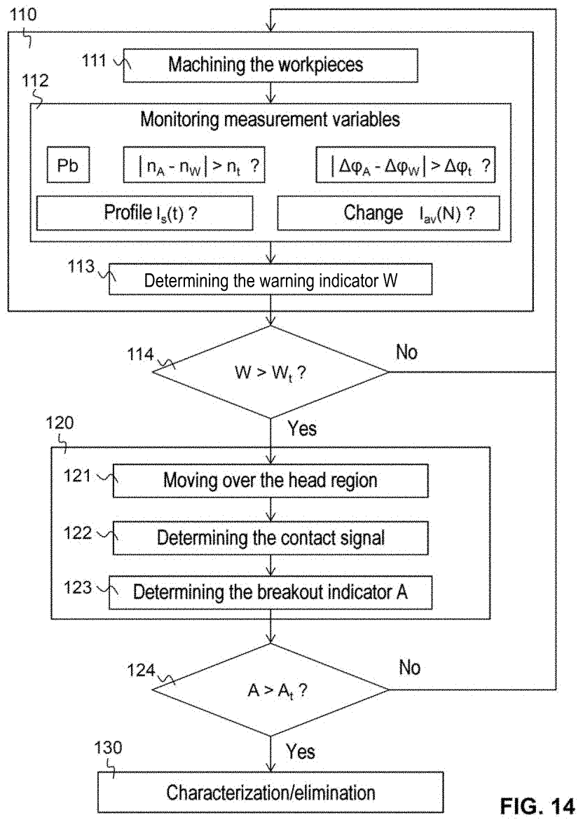

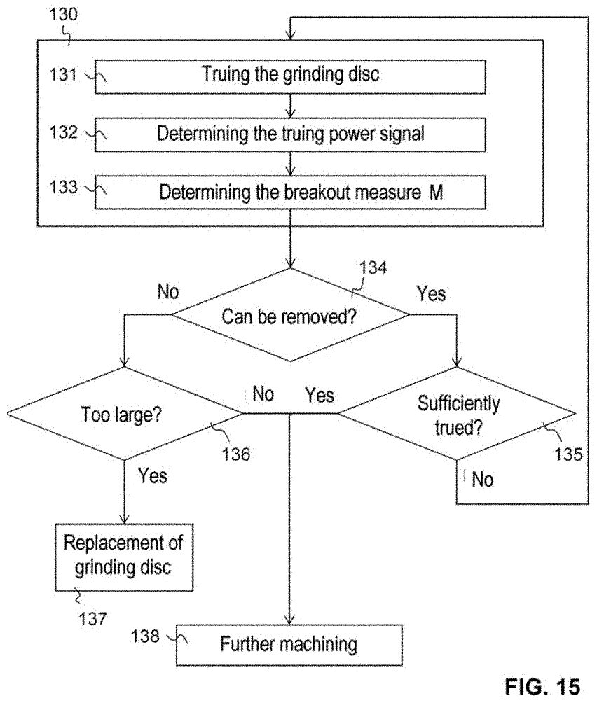

FIGS. 14 and 15 illustrate by way of example a possible method for automatic process control which implements the above concepts.

In the machining process 110, workpieces of a workpiece batch are successively machined with the generating grinding machine. Before and during the machining 111 of each workpiece, inter alia the measured variables explained above are determined and monitored in the monitoring step 112. In particular, the pulse width Pb of the signals of the meshing probe is monitored in order to determine whether pre-machining faults are present. In addition it is monitored whether the difference between the rotational speed n_{w} of the workpiece spindle and the rotational speed n_{A} of the workpiece is larger in absolute terms than a (small) threshold value nₜ. Furthermore it is monitored whether the difference between the change Δφ_{W} in the angle of the workpiece spindle and the change Δφ_{A} in the angle of the workpiece is larger in absolute terms in the course of the machining than a (small) threshold value Δφₜ. In addition, the time course of the power consumption Iₛ(t) of the tool spindle is monitored for each workpiece, and the change in the average spindle current Iₐᵥ(N) from workpiece to workpiece N is monitored. A warning indicator W is determined continuously from the result of these monitoring operations in step 113.

On the basis of the warning indicator, the following decisions are made automatically in a decision step 114:

1. If the warning indicator does not indicate any problems (e.g. so long as it is lower than a threshold value Wₜ), the machining of the workpiece is continued normally.

2. If the warning indicator indicates a possible problem, the machining of the workpiece is stopped temporarily. On the basis of the warning indicator it is decided whether the workpiece is eliminated immediately (this is appropriate e.g. if the warning indicator indicates faulty pre-machining or slipping of the clamped connection of the workpiece), or whether checking of the grinding wheel will be carried out first.

Subsequently, the grinding wheel in step 120 is checked for a possible breakout. In the present example, for this purpose in step 121 the dressing tool is moved over the tip region of the grinding worm threads. In step 122, it is determined by acoustic measurements or power measurements whether there is contact between the dressing tool and the grinding worm, and a contact signal is correspondingly output. In step 123, a breakout indicator A is determined from the time course of the contact signal. In the decision step 124, it is checked whether the breakout indicator A exceeds a predetermined threshold value Aₜ.

If this is not the case, the machining of the workpiece is continued. In this case, if appropriate the cutting power is reduced in order to reduce the probability of the warning indicator indicating possible problems on subsequent workpieces, again.

If, on the other hand, the breakout indicator exceeds the threshold value, the grinding wheel breakout is characterized in more detail and, if appropriate, eliminated in process 130. For this purpose, the grinding wheel is generally dressed with a plurality of dressing strokes (step 131), and during the dressing a dressing power signal is determined for each dressing stroke (step 132). At each dressing stroke a breakout measure M is determined from the dressing power signal (step 133). In the decision step 134 it is checked whether the breakout measure M indicates that the breakout can be appropriately eliminated. If this is not the case, in the decision step 136 it is checked whether the breakout is limited to a sufficiently small region of the grinding wheel so that nevertheless machining can still take place with the undamaged regions of the grinding wheel. If this is not appropriately possible either, in step 137 the operator is instructed to replace the grinding wheel. If, on the other hand, the breakout measure M indicates that it is appropriately possible to eliminate the breakout by dressing, in the decision step 135 it is checked whether the dressing process which was carried out last has already been sufficient to eliminate the breakout. If this is the case, the machining is continued (step 138). Otherwise, the characterization and elimination process 130 is repeated until the breakout measure M indicates that the breakout has been sufficiently eliminated and the machining is continued again.

Overall, it is therefore possible to make a decision automatically, quickly and reliably for each workpiece as to whether machining can take place or whether when in doubt machining which has been carried out is to be checked separately.

Modifications

While the invention has been explained above with reference to the preferred exemplary embodiments, the invention is in no way limited to these examples and a variety of modifications are possible without departing from the scope of the invention. For example, the generating grinding machine can also be constructed differently than in the examples described above, as is well known to a person skilled in the art. The described method can of course, also comprise other measures for monitoring and making decisions.

Further Considerations

In summary, the present invention is based on the following considerations:

Despite the complexity during generating grinding, robust process control, which provides the required quality as far as possible without disruption and quickly, is an objective of automated production. In addition it is appropriate to assign to each gearwheel documentation, produced in an automated fashion, about the machining and end quality of each gearwheel. Online data should be made available for the sake of reliable traceability of all the relevant production steps at the “push of a button” and for generalizing process optimization and/or improvement of efficiency.

The invention therefore employs means to ensure that indications of process deviations, in particular breakouts of various magnitudes, can be detected and a warning signal is outputted. The warning signal can be determined, in particular, on the basis of signals of the meshing probe or by means of the measurement of current values at the tool spindle.

The warning signal can stop the machining immediately, and the workpiece which is entirely or partially machined is eliminated automatically, if appropriate as an NOK part by means of a handling device, and the control device determines and optionally stores the shift position (Y position) of the grinding worm in the case of a defect. Then, the grinding wheel is checked for breakouts. For this purpose, at the working rotational speed of the grinding spindle a minimum absolute value of the tip region of the grinding worm is dressed with a dressing device, and at the same time the current and/or the signal of an acoustic signal is sensed in order to reliably detect breakouts. Alternatively, checking for breakouts is carried out with another method, e.g. optically, acoustically by means of a jet of coolant, or by means of a complete dressing stroke. This process can also be executed by the meshing probe at defined intervals and without a warning signal, because in this way it is possible to detect relatively small breakouts on the grinding worm which have not come about as a result of incorrectly machined workpieces. If this measurement detects a breakout, the control device makes the following decisions:
further machining of the production batch and blocking off the damaged region on the grinding worm to prevent further machining;
dressing of the grinding worm and then possibly also performing further machining with reduced metal-cutting values; or

replacing the grinding worm and completing the machining of the production batch with a new grinding worm.

During the dressing of the grinding wheel it is to be noted that the first dressing strokes are usually executed with the settings for the production batch. In the case of large and very large breakouts, a large dressing time can then become necessary. In this context, adaptive or self-learning dressing can bring about large savings in time, and replacement of the grinding worm which is also time-consuming can be avoided.

However, if this measurement does not detect a breakout on the grinding worm even though a warning signal has been determined, the control device makes the following decisions:
further machining of the production batch with reduced metal-cutting values; or
stopping machining of the production batch and informing the operator.

For this purpose, automatic process monitoring of a production batch during grinding and dressing can be carried out by means of a CNC generating grinding machine with peripheral automation technology for transportation of the workpiece using a separate control device with a connected server. The control device is configured in such a way that preferably all the sensor data of the generating grinding machine, the corresponding settings and machining values, preferably the power values at the tool spindle, workpiece spindle and dressing spindle, and the signals of the meshing probe are continuously sensed and stored in a server for each workpiece of a production batch. In this case, it is optionally possible for time-neutral component monitoring to take place at each automatically executed workpiece change, which monitoring clears machining if no objection occurs. Inter alia, a cutting power signal and an cutting energy indicator are also determined, which signal and indicator are correlated with the other data in the control device and, after the machining of the first workpieces, also with the stored data in the server. The warning indicator can then be outputted at an early point.

### LIST OF REFERENCE SYMBOLS

1 Generating grinding machine
11 Machine bed
12 Tool carrier
13 Axial carriage
14 Grinding head
15 Tool spindle
16 Grinding wheel
17 Measuring probe
18 Acoustic sensor
19 Coolant nozzle
20 Workpiece carrier
21 Workpiece spindle
22 Tailstock
23 Workpiece
24 Meshing probe
31 Pivoting device
32 Dressing spindle
33 Dressing tool
40 Machine controller
41 Axis modules
42 Control device
43 CNC operator control panel
44 Server
51 Grinding wheel breakout
52 Tooth
61-63 Measuring curve
64 Time course of current
65 Dressing time
71 Measuring curve
72 Gap
81 Measuring curve
82 Envelope curve
83 Mean value
84 Minimum value
85 Maximum value
110 Machining process
111 Machining of the workpiece
112 Monitoring
113 Determination of W
114 Decision step
120 Breakout detection process
121 Moving over
122 Determination of contact signal
123 Determination of A
124 Decision step
130 Characterization/removal
131 Dressing
132 Determination of dressing power
133 Determination of M
134-136 Decision steps
137 Replacement of grinding wheel
138 Further machining
a.u. Arbitrary unit
A Breakout indicator
Aₜ Threshold value of breakout indicator
—B Tool axis
C1 Tool axis
C3 Pivoting axis of workpiece carrier
C4 Pivoting axis of dressing device
Iₐᵥ Average power consumption of tool spindle
I_{d} Power consumption of dressing spindle
Iₛ Power consumption of tool spindle
M Breakout measure
n_{A} Workpiece rotational speed
nₜ Threshold value of rotational speed difference
n_{W} Rotational speed of workpiece spindle
N Number of workpieces in batch
Pb Pulse width of meshing signal/tooth
Pd Duration of signal period of meshing signal/tooth
t Time
Vₐ Acoustic signal
W Warning indicator
Wₜ Threshold value of warning indicator
X Infeed direction
Y Shifting axis
Z Axial direction
Δφ_{A} Change in angle of workpiece
Δφₜ Threshold value of difference of change in angle
Δφ_{W} Change in angle of workpiece spindle

1. A method for automatic process control during continuous generating grinding of pre-toothed workpieces with a generating grinding machine,
the generating grinding machine comprising a tool spindle and at least one workpiece spindle, a grinding wheel having a worm-shaped profile with one or more worm threads being clamped onto the tool spindle, the grinding wheel being rotatable about a tool axis, and the workpieces being adapted to be clamped onto the at least one workpiece spindle,
wherein the method comprises:
machining the workpieces with the generating grinding machine, wherein for the machining the workpieces are clamped onto the at least one workpiece spindle and are successively moved into generating engagement with the grinding wheel;
monitoring at least one measured variable during the machining of the workpieces; and
determining a warning indicator for an unacceptable process deviation is determined from the at least one monitored measured variable.

2. The method according to claim 1, wherein the warning indicator is a warning indicator for a grinding wheel breakout.

3. The method according to claim 2, further comprising:
automatically checking the grinding wheel for a grinding wheel breakout if the warning indicator indicates a grinding wheel breakout.

4. The method according to claim 3, wherein the generating grinding machine comprises a dressing device with a dressing tool, and wherein the automatic checking of the grinding wheel for a grinding wheel breakout comprises the following steps:
moving the dressing tool over a tip region of the grinding wheel;
determining a contact signal during the movement over the tip region, the contact signal indicating contact of the dressing tool with the tip region of the grinding wheel; and
determining a breakout indicator by analyzing the contact signal, the breakout indicator indicating whether a grinding wheel breakout is present.

5. The method according to claim 4, wherein the generating grinding machine comprises an acoustic sensor in order to detect acoustically the engagement of the dressing tool with the grinding wheel, and wherein the contact signal comprises an acoustic signal which is determined using the acoustic sensor.

6. The method according to claim 4, wherein the dressing device comprises a dressing spindle on which the dressing tool is clamped, and wherein the contact signal comprises a tip dressing power signal which is representative of the power consumption of the dressing spindle during the movement over the tip region.

7. The method according to claim 4, wherein the breakout indicator indicates a location of the grinding wheel breakout along at least one of the worm threads of the grinding wheel.

8. The method according to claim 4, wherein the method comprises:
dressing the grinding wheel if the breakout indicator indicates the presence of a grinding wheel breakout.

9. The method according to claim 3, wherein the generating grinding machine comprises a dressing device with a dressing tool, and wherein the automatic checking of the grinding wheel for a grinding wheel breakout comprises dressing the grinding wheel with at least one dressing stroke.

10. The method according to claim 9, wherein the dressing device comprises a dressing spindle on which the dressing tool is clamped, and wherein the method comprises:
determining a dressing power signal during the dressing, wherein the dressing power signal is representative of the power consumption of the dressing spindle or tool spindle during the dressing;
determining a breakout measure by analyzing a time course of the dressing power signal during the dressing, the breakout measure reflecting at least one characteristic of the grinding wheel breakout; and
depending on the breakout measure, repeating the dressing of the grinding wheel.

11. The method according to claim 10, wherein the analysis of the time course of the dressing power signal includes:
determining a fluctuation variable, wherein the fluctuation variable indicates local changes in the magnitude of the dressing power signal along at least one of the worm threads.

12. The method according to claim 1,
wherein the at least one monitored measured variable comprises a deviation indicator for an upper deviation of tooth thickness of the workpiece before the machining; and/or
wherein the at least one monitored measured variable comprises a rotational speed difference between a rotational speed of the workpiece spindle and a resulting rotational speed of the workpiece, and/or
wherein the at least one monitored measured variable comprises an angular deviation which has been determined by a comparison of an angular position of the workpiece spindle after the machining of the workpiece, a corresponding angular position of the workpiece itself, an angular position of the workpiece spindle before the machining of the workpiece and a corresponding angular position of the workpiece itself.

13. The method according to claim 12, wherein the generating grinding machine comprises a meshing probe for determining in a contactless fashion an angular position of a workpiece which is clamped onto the at least one workpiece spindle, and wherein the deviation indicator, the rotational speed and/or the respective angular position of the workpiece are/is sensed with the meshing probe.

14. The method according to claim 1, wherein the at least one monitored measured variable comprises a cutting power signal which indicates an instantaneous metal-cutting power during the machining of each individual workpiece, and wherein the warning indicator depends on the time course of the cutting power signal over the machining of a workpiece.

15. The method according to claim 14, wherein the cutting power signal is a measure of instantaneous power consumption of the tool spindle during the machining of a workpiece.

16. The method according to claim 1,
wherein the method comprises executing a continuous or discontinuous shifting movement between the grinding wheel and the workpieces along the tool axis;
wherein the at least one monitored measured variable comprises a cutting energy indicator for each workpiece,
wherein the cutting energy indicator represents a measure for an integrated metal-cutting power of the grinding wheel while the respective workpiece was machined with the generating grinding machine; and
wherein the warning indicator depends on how the cutting energy indicator changes over the production of a plurality of workpieces of one production batch.

17. The method according to claim 16, wherein the cutting energy indicator is a measure of the integral of power consumption of the tool spindle during the machining of an individual workpiece.

18. The method according to claim 1, further comprising storing the at least one monitored measured variable and/or at least one variable derived therefrom in a database together with an unambiguous identifier of the respective workpiece.

19. A generating grinding machine comprising:
a tool spindle on which a grinding wheel having a worm-shaped profile with one or more worm threads can be clamped, and configured to be driven to rotate about a tool axis;
at least one workpiece spindle for driving a pre-toothed workpiece to rotate about a workpiece axis; and
a machine controller configured to execute a method according to claim 1.

20. A non-volatile computer-readable medium comprising a computer program, the computer program comprising instructions which cause a machine controller in a generating grinding machine that further comprises a tool spindle on which a grinding wheel having a worm-shaped profile with one or more worm threads can be clamped, and configured to be driven to rotate about a tool axis and at least one workpiece spindle for driving a pre-toothed workpiece to rotate about a workpiece axis, to carry out the method according to claim 1.

21. (canceled)

22. The method according to claim 14, wherein the warning indicator depends on the occurrence of a pulse-like increase in the cutting power signal during the machining.

23. The method according to claim 18, comprising storing the warning indicator in the database together with the unambiguous identifier.
